(19) United States
(12) Patent Application Publication
(10) Pub. No.: US 2002/0176138 A1
(43) Pub. Date: Nov. 28, 2002

(54) Infrared encoder/decoder having hardware and software data rate selection

(76) Inventor: Steven Eric Schlanger, Flagstaff, AZ (US)

Correspondence Address: BAKER BOTTS, LLP, 910 LOUISIANA, HOUSTON, TX, 77002-4995, US

(21) Appl. No.: 09/862,079

(22) Filed: May 21, 2001

(51) Int. Cl. H04B 10/00; H04B 10/04

(52) U.S. Cl. 359/172; 359/182

(57) ABSTRACT

An infrared encoder/decoder selects the data rate of a serial transmission of data by changing an input clock speed, setting the operating characteristics of a clock divider circuit by hardware inputs or selecting a clock speed by software commands that program the operating characteristics of a clock divider circuit. Having three alternate ways, two hardware and one software, of selecting the data rate of the serial transmission allows greater flexibility in the application and interfacing of a single integrated circuit package infrared encoder/decoder with all types of digital logic circuits and systems. An encoder/decoder having standard pulse width output and input compatibility with infrared industry standards, e.g., IrDA, and infrared transceivers is achieved in a flexible and cost effective low power integrated circuit package.

### FIELD OF THE INVENTION

The present invention relates generally to wireless infrared communications, and more particularly to an infrared encoder/decoder having hardware and software data rate selection.

### BACKGROUND OF THE INVENTION TECHNOLOGY

Wireless communications links, such as infrared (IR), between two or more devices require a robust communications protocol. The devices at each end of an IR link may move freely within range and out of range. The IR link may be broken in the middle of a transmission, or may suffer interference from external light sources. The Infrared Data Association (IrDA) is an organization which promotes an IR standard for interoperability of wireless IR links between various manufacturers devices. The IrDA defines a set of specifications, or protocol stack, that provides for the establishment and maintenance of an IR link so that error free communication is possible. The IrDA Standard includes three mandatory specifications: the Physical Layer, Link Access Protocol (IrLAP), and Link Management Protocol (IrLMP). The first version of the IrDA specification, Version 1.0, provided for communication at data rates up to 115.2 Kb/s. Version 1.1 extended the data rates up to 4 Mb/s, while maintaining backward compatibility with Version 1.0 compliant products. All IrDA Specifications are incorporated by reference herein for all purposes.

IrDA devices generally communicate over a distance of from 0 cm to about 1 meter. IrDA data rates range from 2.4 Kb/s to 4 Mb/s. Link data rate is negotiated when the link starts up between devices. IrDA requires that a link always start up at 9.6 Kb/s, but then allows the devices at either ends of the link to negotiate higher or lower data rates if supported by both devices. Data rates of less than 4 Mb/s use a return to zero, inverted (RZI) modulation, and the 4 Mb/s data rate uses a 4 pulse position modulation (PPM). According to the IrDA specification, the pulse width of the RZI modulation is generally 3/16 of the maximum pulse width (clock rate) or about 1.6 microseconds (selectable).

Serial data sent to and from devices, e.g., computer, processor or serial device (UART), printer, camera, cell phone, pager, air keyboard and mouse is generally either at a high (on) or low (off) logic level depending upon the bit pattern of the serially transmitted data word. This type of serial data format is converted into RZI pulses using pulse frequency or pulse skipping modulation (PFM), pulse width modulation (PWM), or PPM for transmission by an IR transceiver, e.g., Agilent Technologies part number HSDL-1001. Short duration on pulses must be used with an IR transmitter so as not to overheat the IR transmitter (high current consumption) or unduly drain the power supply battery. The received short duration pulses must also be converted back into compatible serial data format for processing in the serial data decode logic of the device.

An IR encoder/decoder (Endec) is coupled between each IR transceiver and the serial data device. The IR link comprises serial, half duplex (transmit or receive, but not both at the same time) data communication between IR coupled devices. The Endec converts the serial data to be transmitted to short duration pulses according to the IrDA specification, and converts the received short duration pulses back to compatible serial data again. The baud rate of the IR pulses is determined by the clock speed at which the pulses are being sent. Clock speed may be determined by the speed of an external clock oscillator coupled to the Endec, e.g., Agilent Technologies part number HSDL-7000, or the clock speed may be generated by the Endec internal clock oscillator or from an external clock oscillator and then adjusted to the desired clock speed by frequency divider circuits in the Endec, e.g., Agilent Technologies part number HSDL-7001. Clock speed adjustment is important in an IrDA communications link because once the two devices have negotiated a desired communications baud rate at the beginning baud rate of 9600 b/s, each Endec may be required to shift to the agreed upon baud rate speed.

Changing baud rates of the IR pulses is accomplished in present technology Endecs either by changing the speed of an external clock (HSDL-7000) to the Endec, or using hardware selection signals to control the operation of a frequency divider in the Endec so as to divide the frequency of either an internal or external clock oscillator. In either way, changing baud rates requires special hardware, interface connections and different models of Endecs for each type of application.

What is needed is an Endec that may be used for a plurality of different IrDA applications and, in addition, is easier to interface to, control and operate than present technology Endecs.

### SUMMARY OF THE INVENTION

The invention overcomes the above-identified problems as well as other shortcomings and deficiencies of existing technologies by providing hardware and software methods, system and apparatus for selecting the data rate of an infrared wireless communications link between two devices. An infrared encoder/decoder is adapted for selecting the data rate by changing a clock frequency to produce a desired serial clock rate. The desired serial clock rate may be selected by changing an external clock frequency to the encoder/decoder, or by controlling a frequency divider that is integral with the encoder/decoder. The frequency divider may be controlled with hardware digital logic signal inputs or software program instructions.

Having three alternate ways, two hardware and one software, of selecting the data rate of the serial transmission allows greater flexibility in the application and interfacing of a single integrated circuit package infrared encoder/decoder with all types of digital logic circuits and systems. An encoder/decoder having standard pulse width output and input compatibility with infrared industry standards, e.g., IrDA, and infrared transceivers is achieved in a flexible and cost effective low power integrated circuit package.

The infrared encoder/decoder may be for example, but not limited to, a microcontroller, a microprocessor, a programmable logic array (PLA), an application specific integrated circuit (ASIC), digital logic and the like.

In accordance with an exemplary embodiment of the present invention, an apparatus for encoding and decoding serial data to and from an infrared transmitter and receiver, respectively, comprises an encoder adapted for receiving transmit serial data at a serial clock rate and encoding the transmit serial data into transmit pulses compatible with an infrared transmitter, a decoder adapted for receiving receive pulses from an infrared receiver and decoding the receive pulses into receive serial data at the serial clock rate, and a clock frequency divider adapted for dividing a clock frequency by a division value to produce the serial clock rate, said clock frequency divider having control logic for selecting the division value, wherein the division value is a positive integer selected by hardware logic signals or software instructions.

The present invention is also directed to a method of operation for encoding and decoding serial data to and from an infrared transmitter and receiver, respectively, said method comprising the steps of receiving transmit serial data at a serial clock rate and encoding the transmit serial data into transmit serial pulses compatible with an infrared transmitter, receiving receive serial pulses from an infrared receiver and decoding the receive pulses into receive serial data at the serial clock rate; and dividing a clock frequency by a division value to produce the serial clock rate, wherein the division value is a positive integer selected by hardware logic signals or software instructions.

In addition, the present invention is directed to a system for infrared communications between two or more devices, said system comprising first device application logic adapted for sending transmit serial data at a serial clock rate and receiving receive serial data at the serial clock rate, an encoder having an input coupled to said first device application logic, said encoder receiving the transmit serial data and encoding the transmit serial data into transmit pulses at an output of said encoder, an infrared transmitter coupled to the output of said encoder, said infrared transmitter converting the transmit pulses into infrared light pulses, an infrared receiver adapted for receiving infrared light pulses and converting the infrared light pulses into receive pulses, a decoder having an input coupled to said infrared receiver and receiving the receive pulses, said decoder decoding the receive pulses into receive serial data at the serial clock rate, said first device application logic adapted for receiving the receive pulses, and a clock frequency divider adapted for dividing a clock frequency by a division value to produce the serial clock rate, said clock frequency divider having control logic for selecting the division value, wherein the division value is a positive integer selected by hardware logic signals or software instructions.

A technical advantage of the present invention is a single infrared encoder/decoder that may be used for different applications and with different devices.

Another technical advantage is a reduction in the system resources needed to setup the encoder/decoder by using software instructions for baud rate control instead of hardware I/O resources.

A feature of the present invention is flexibility in the application of a single design of an infrared encoder/decoder for many different interface applications.

Another feature is software control of a frequency divider for selecting a desired serial clock rate.

Another feature is hardware control of a frequency divider for selecting a desired serial clock rate.

Another feature is changing an external clock frequency for selecting a desired serial clock rate.

Features and advantages of the invention will be apparent from the following description of the embodiments, given for the purpose of disclosure and taken in conjunction with the accompanying drawings.

### BRIEF DESCRIPTION OF THE DRAWINGS

A more complete understanding of the present disclosure and advantages thereof may be acquired by referring to the following description taken in conjunction with the accompanying drawing, wherein:

FIG. 1 illustrates a schematic block diagram of a device adapted for infrared communications with another device according to an exemplary embodiment of the invention.

While the present invention is susceptible to various modifications and alternative forms, specific exemplary embodiments thereof have been shown by way of example in the drawing and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF SPECIFIC EMBODIMENTS

The present invention is directed to a method, system and apparatus for selecting a data rate of an infrared wireless communications link between two devices. In the exemplary embodiments of the invention, an infrared encoder/decoder is adapted for selecting a serial data baud rate by changing a clock frequency to produce a desired serial clock rate. The desired serial clock rate may be selected by changing an external clock frequency to the encoder/decoder, or by controlling a frequency divider that is integral with the encoder/decoder. The frequency divider may be controlled with hardware signal inputs or software program instructions.

Referring now to the drawing, the details of an exemplary embodiment of the present invention are schematically illustrated. Like elements in the drawing will be represented by like numbers, and similar elements will be represented by like numbers with a different lower case letter suffix.

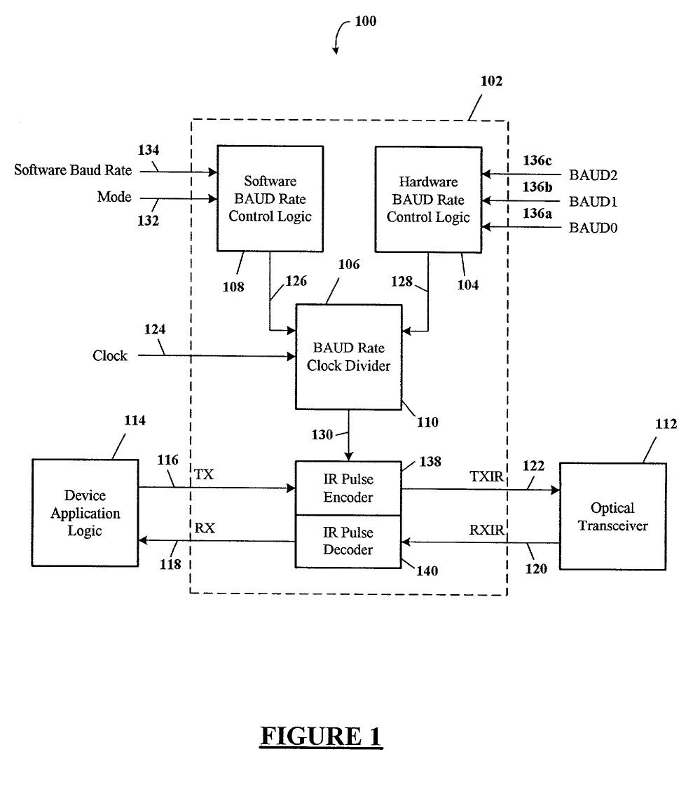

Referring to FIG. 1, depicted is a schematic block diagram of a device adapted for infrared communications with another device, according to an exemplary embodiment of the invention. The device having infrared communications capabilities is generally represented by the numeral 100 and comprises device application logic 114, an optical transceiver 112 and comprising an exemplary embodiment of the invention, depicted by the numeral 102, a software BAUD rate control logic 108, hardware BAUD rate control logic 104, a BAUD rate clock divider 110, an IR pulse encoder 138 and an IR pulse decoder 140. The exemplary embodiment of the invention 102 may be fabricated on a semiconductor integrated circuit. The device application logic 114 may be any digital and/or mixed digital/analog device, e.g., microcontroller, microprocessor, programmable logic array (PLA), application specific integrated circuit (ASIC), digital signal processor (DSP) and the like. Random access memory (RAM) and read only memory (ROM) may also be coupled to and used with the device application logic 114 Devices may be any apparatus that uses IR light pulses for communications with another device.

The device application logic 114 sends transmit serial data 116 (TX) to an input of the IR pulse encoder 138. The IR pulse encoder 138 encodes the transmit serial data 116 into transmit electrical pulses 122 (TXIR) compatible with IR light transmission. The pulses 122 are coupled to an IR transmitter portion (not illustrated) of the optical transceiver 112 for transmission by IR light pulses. The BAUD rate of the pulses 122 is determined by a serial clock rate 130 from the BAUD rate clock divider 110.

IR light pulses are received by an IR optical receiver (not illustrated) of the optical transceiver 112. These received IR light pulses are detected by the IR optical receiver into receive electrical pulses 120 (RXIR) which are coupled to the IR pulse decoder 140. The IR pulse decoder 140 decodes the receive electrical pulses 120 (RXIR) into receive serial data 118 (RX) and sends the receive serial data 118 (RX) to the device application logic 114. The BAUD rate of the pulses 122 is determined by a serial clock rate 130 from the BAUD rate clock divider 110.

Another device 100a (not illustrated) may have similar circuits described herein and be adapted to communicate by IR light pulses with the device 100.

The BAUD rate clock divider 110 may be adapted to receive a clock frequency 124. The BAUD rate clock divider may preferably be set to divide the clock frequency 124 by a positive integer, e.g., 1, 2, 3, 4, 5, 6, 7, 8, etc., to produce the serial clock rate 130. For example but not limited to, the clock frequency 124 may be an integer multiple of 16 so that there are at least 16 clock pulses for each pulse of the serial clock rate 130. This allows the pulse width of the transmit IR pulse 122 (TXIR) to be, for example, 3/16 of the serial clock rate 130. Other pulse widths that are shorter or longer than 3/16 of the serial clock rate 130 may be used and are contemplated herein. In addition the pulse width may be set to a fixed or variable time duration that is independent of the serial clock rate 130. The pulse width time duration may be from about less than several hundred nanoseconds to about over half of the serial clock rate 130.

A first mode of operation may be configured by setting the BAUD rate inputs 136 of the hardware BAUD rate control logic 104 to a desired BAUD rate input code. Inputs 136a-136c (BAUD0, BAUD1 and BAUD2) are used to select the BAUD rate at which the device 100 will transmit and receive. In addition, the inputs 136a-136c may be used to select a second mode of operation which is software controlled by the software BAUD rate control logic 108. It is contemplated and within the scope of the invention that more or less than three inputs 136 may be utilized for hardware BAUD rate selection. Hardware BAUD rate control is sent to the BAUD rate clock divider 110 over control bus 128. A list of exemplary representative BAUD rate input codes and BAUD rates are listed in Table I herein.

TABLE I

| BAUD2:BAUD0 | BAUD Rate |
|---|---|
| 000 | 4,800 |
| 001 | 9,600 |
| 010 | 19,200 |
| 011 | 28,800 |
| 100 | 57,600 |
| 101 | 115,200 |
| 110 | 230,400 |
| 111 | Software Selection |

A second mode of operation occurs when the BAUD rate inputs 136 are all at a logic high (all 1s). In the second mode, the device may default to a BAUD rate of 9600 and the software BAUD rate control logic 108 now controls the operation of the BAUD rate clock divider 110. Software programming of the BAUD rate may be done through the software baud rate input 134 which is decoded by the software BAUD rate control logic 108 and the desired baud rate is then sent over control bus 126 to the BAUD rate clock divider 110.

Another exemplary embodiment connects the software baud rate input 134 to the transmit serial data 116 (TX) output from the device application logic 114. A mode control input 132 may be adapted to select whether the serial information at the input 132 is to be used for controlling the BAUD rate control logic 108 or is to used as transmit serial data 116 to the IR pulse encoder 138. In this exemplary embodiment, the baud rate input 134 and transmitted serial data 116 (TX) originate from the same serial output port of the device application logic 114 and are time division multiplexed by the mode signal 132. Thus, simple software program control of the baud rate of the IR communications link may be easily accomplished before sending data. When the mode signal 132 is at a first logic level, data sent over baud rate input 134 may be echoed back over the receive serial data 118 and no transmit data will be accepted by the IR pulse encoder 138. When the mode signal 132 is at a second logic level, the transmit serial data 116 to the IR pulse encoder is accepted and there is normal encoding of the transmit serial data 116 to transmit electrical pulses 122 by the IR pulse encoder 138. The baud rate may remain the same as was last programmed through the software baud rate input 134. Any time the baud rate must be changed, the steps described herein may be repeated.

The present invention may function so as to accommodate an infrared standard such as Infrared Data Association (IrDA) Serial Physical Layer Specification, version 1.3 (Oct. 15, 1998) and IrDA Control Specification, final revision (Jun. 30, 1998), both IrDA standards being incorporated by reference herein for all purposes.

All baud rates, pulse widths and modulation methods that will function in an infrared transmission environment are contemplated herein and are within the scope of the present invention.

The device application logic 114 may be any type of digital circuit having serial digital data communications capabilities, e.g., a microcomputer with a UART, a central processing unit (CPU) and UART, a reduced instruction set computer (RISC) or complex instruction set computer (CISC) and a UART, a digital signal processor and the like. The device application logic 114 may also comprise a random access memory (not illustrated) and read only memory (not illustrated).

The invention, therefore, is well adapted to carry out the objects and attain the ends and advantages mentioned, as well as others inherent therein. While the invention has been depicted, described, and is defined by reference to exemplary embodiments of the invention, such references do not imply a limitation on the invention, and no such limitation is to be inferred. The invention is capable of considerable modification, alternation, and equivalents in form and function, as will occur to those ordinarily skilled in the pertinent arts and having the benefit of this disclosure. The depicted and described embodiments of the invention are exemplary only, and are not exhaustive of the scope of the invention. Consequently, the invention is intended to be limited only by the spirit and scope of the appended claims, giving full cognizance to equivalents in all respects.

What is claimed is:

1. An apparatus for encoding and decoding serial data to and from an infrared transmitter and receiver, respectively, comprising:
an encoder adapted for receiving transmit serial data at a serial clock rate and encoding the transmit serial data into transmit pulses compatible with an infrared transmitter;
a decoder adapted for receiving receive pulses from an infrared receiver and decoding the receive pulses into receive serial data at the serial clock rate; and
a clock frequency divider adapted for dividing a clock frequency by a division value to produce the serial clock rate, said clock frequency divider having control logic for selecting the division value, wherein the division value is a positive integer selected by hardware logic signals or software instructions.

2. The apparatus according to claim 1, further comprising changing the serial clock rate by changing the frequency of the clock.

3. The apparatus according to claim 1, wherein the clock frequency is an integer multiple of the serial clock rate.

4. The apparatus according to claim 3, wherein the transmit pulse width is less than or equal to one half of the serial clock rate.

5. The apparatus according to claim 1, wherein the transmit pulse width is less than the serial clock rate.

6. The apparatus according to claim 1, wherein the transmit pulses are pulse position modulation.

7. The apparatus according to claim 1, wherein the transmit pulses are selected from the group consisting of pulse frequency modulation, pulse skipping modulation and pulse width modulation.

8. The apparatus according to claim 1, wherein the software instructions for selection of the division value is sent on the same serial input as the transmit serial data.

9. The apparatus according to claim 8, further comprising a mode selection input for switching between the software instructions for selection of the division value and the transmit serial data

10. The apparatus according to claim 1, wherein said device application logic is selected from the group consisting of a microcontroller, a microprocessor, digital signal processor, a programmable logic array and an application specific integrated circuit.

11. The apparatus according to claim 1, wherein said device application logic comprises a central processing unit, a random access memory and a read only memory.

12. A method for encoding and decoding serial data to and from an infrared transmitter and receiver, respectively, said method comprising the steps of:
receiving transmit serial data at a serial clock rate and encoding the transmit serial data into transmit pulses compatible with an infrared transmitter;
receiving receive pulses from an infrared receiver and decoding the receive pulses into receive serial data at the serial clock rate; and
dividing a clock frequency by a division value to produce the serial clock rate, wherein the division value is a positive integer selected by hardware logic signals or software instructions.

13. The method according to claim 12, further comprising the step of changing the serial clock rate by changing the frequency of the clock.

14. The method according to claim 12, further comprising the step of selecting between software instructions for selection of the division value and the transmit serial data

15. A system for infrared communications between two or more devices, said system comprising:
first device application logic adapted for sending transmit serial data at a serial clock rate and receiving receive serial data at the serial clock rate;
an encoder having an input coupled to said first device application logic, said encoder receiving the transmit serial data and encoding the transmit serial data into transmit pulses at an output of said encoder;
an infrared transmitter coupled to the output of said encoder, said infrared transmitter converting the transmit pulses into infrared light pulses;
an infrared receiver adapted for receiving infrared light pulses and converting the infrared light pulses into receive pulses;
a decoder having an input coupled to said infrared receiver and receiving the receive pulses, said decoder decoding the receive pulses into receive serial data at the serial clock rate, said first device application logic adapted for receiving the receive pulses; and
a clock frequency divider adapted for dividing a clock frequency by a division value to produce the serial clock rate, said clock frequency divider having control logic for selecting the division value, wherein the division value is a positive integer selected by hardware logic signals or software instructions.

16. The system according to claim 15, further comprising changing the serial clock rate by changing the frequency of the clock.

17. The system according to claim 15, wherein the clock frequency is an integer multiple of the serial clock rate.

18. The system according to claim 17, wherein the transmit pulse width is less than or equal to one half of the serial clock rate.

19. The system according to claim 15, wherein the transmit pulses are transmitted as pulse position modulation.

20. The system according to claim 15, wherein the transmit pulse width is less than the serial clock rate.

21. The system according to claim 15, wherein the serial clock rate is from about 800 baud to about 312,500 baud.

22. The system according to claim 15, wherein the serial clock rate is from about 115 kilobaud to about 10 megabaud.

23. The system according to claim 22, further comprising a mode selection input for switching between the software instructions for selection of the division value and the transmit serial data.

24. The system according to claim 15, wherein said device application logic is selected from the group consisting of a microcontroller, a microprocessor, digital signal processor, a programmable logic array and an application specific integrated circuit.

25. The system according to claim 15, wherein said device application logic comprises a central processing unit, a random access memory and a read only memory.

26. The system according to claim 15, wherein the transmit pulses are pulse position modulation.

27. The system according to claim 15, wherein the transmit pulses are selected from the group consisting of pulse frequency modulation, pulse skipping modulation and pulse width modulation.

28. The system according to claim 15, wherein the software instructions for selection of the division value is sent on the same serial input as the transmit serial data.
